(19) United States
(12) Patent Application Publication
(10) Pub. No.: US 2026/0364946 A1
(43) Pub. Date: Nov. 19, 2026

(54) TUBE PUMP, LIQUID EJECTION DEVICE, AND INKJET RECORDING APPARATUS

(71) Applicant: KYOCERA Document Solutions Inc., Osaka (JP)

(72) Inventors: Koichi Imanaka, Osaka (JP); Kenichi Satake, Osaka (JP); Hideki Ishida, Osaka (JP); Shogo Yoneda, Osaka (JP); Nanako Nishida, Osaka (JP); Shun Tsuboi, Osaka (JP)

(21) Appl. No.: 19/651,522

(22) Filed: Apr. 17, 2026

(30) Foreign Application Priority Data
May 13, 2025 (JP) 2025-080261

(51) Int. Cl. B41J 2/175; B41J 2/165; F04B 43/09

(52) U.S. Cl. CPC B41J 2/17596; B41J 2/16523; B41J 2/16532; F04B 43/09; B41J 2002/16594

(57) ABSTRACT

In a tube pump, a transmission mechanism transmits rotary force of one driving source. Each of the plurality of pump units is couplable to the transmission mechanism. Each of the plurality of pump units includes a body, an inlet port, an outlet port, a flexible tube, and a rotor. The tube is connected to the inlet port and the outlet port. The tube includes an arcuate portion disposed along an arcuate inner surface in the body. The rotor includes a plurality of rollers that each presses a part of the arcuate portion in the tube. The rotor rotates upon receiving the rotary force transmitted by the transmission mechanism.

### INCORPORATION BY REFERENCE

This application is based upon and claims the benefit of priority from the corresponding Japanese Patent Application No. 2025-080261 filed on May 13, 2025, the entire contents of which are incorporated herein by reference.

### BACKGROUND

This disclosure relates to a tube pump changeable in ejection performance and a liquid ejection device and an inkjet recording apparatus each including the tube pump.

An inkjet recording apparatus includes an ink ejection device that forms an image on a sheet by ejecting an ink drop to the sheet from an inkjet head. The ink ejection device is an example of a liquid ejection device that ejects a liquid drop. The inkjet head is an example of a liquid ejection head.

The inkjet recording apparatus includes an ink supply device that supplies ink from an ink storage portion to the inkjet head through a supply path. The ink supply device includes a pressure pump disposed in the supply path.

Furthermore, the inkjet recording apparatus includes an ink discharge device in some cases. The ink discharge device discharges ink in the inkjet head through a discharge path. The ink discharge device includes a suction pump disposed in the discharge path.

For example, it has been known that a tube pump is adopted for the inkjet recording apparatus as the pressure pump or the suction pump.

### SUMMARY

A tube pump according to an aspect of this disclosure includes one driving source, a transmission mechanism, and a plurality of pump units. The driving source outputs rotary force. The transmission mechanism transmits the rotary force of the driving source. Each of the plurality of pump units is couplable to the transmission mechanism. Each of the plurality of pump units includes a body, an inlet port and an outlet port, a flexible tube, and a rotor. The body has an arcuate inner surface formed in the shape of a circular arc. The inlet port and the outlet port are supported by the body and each form a channel for fluid. The tube is disposed in the body and connected to the inlet port and the outlet port. The tube includes an arcuate portion disposed along the arcuate inner surface. The rotor includes a plurality of rollers that each presses a part of the arcuate portion in the tube. The rotor rotates upon receiving the rotary force transmitted by the transmission mechanism.

A first liquid ejection device according to another aspect of this disclosure includes a liquid ejection head, a supply path, and the tube pump disposed in the supply path. The liquid ejection head includes a plurality of nozzles. The liquid ejection head ejects a liquid drop from each of the plurality of nozzles. Liquid to be supplied to the liquid ejection head flows in the supply path.

A second liquid ejection device according to another aspect of this disclosure includes the liquid ejection head and a liquid discharge device. The liquid discharge device discharges liquid in the liquid ejection head. The liquid discharge device includes a cap that covers the plurality of nozzles, a discharge path that communicates with the inside of the cap, and the tube pump disposed in the discharge path.

An inkjet recording apparatus according to another aspect of this disclosure includes a sheet conveying device that conveys a sheet and the liquid ejection device that forms an image on the conveyed sheet by ejecting an ink drop to the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an inkjet recording apparatus according to an embodiment.

FIG. 2 is a configuration diagram of an ink supply device, an inkjet head, and an ink discharge device in the inkjet recording apparatus according to the embodiment.

FIG. 3 is a perspective view of a tube pump in the inkjet recording apparatus according to the embodiment.

FIG. 4 is a cross-sectional view of a pump unit of the tube pump in the inkjet recording apparatus according to the embodiment.

FIG. 5 is a perspective view of a part of the tube pump in the inkjet recording apparatus according to the embodiment.

FIG. 6 is a perspective view of a part of the tube pump in the inkjet recording apparatus according to the embodiment.

FIG. 7 is a diagram showing an example of a connection mode between the tube pump and a supply path in the inkjet recording apparatus according to the embodiment.

### DETAILED DESCRIPTION

Hereinafter, an embodiment of this disclosure will be described with reference to the drawings. It is noted that the following embodiment is a specific example of this disclosure and does not limit the technical scope of this disclosure.

### Configuration of Inkjet Recording Apparatus 10

An inkjet recording apparatus 10 according to the embodiment is an image forming apparatus capable of executing a print process in an inkjet scheme. The print process is a process of forming an image on a sheet 9. The sheet 9 is a sheet-shaped image forming medium such as paper or a resin film.

It is noted that the inkjet recording apparatus 10 may be a facsimile apparatus, a copier, a multifunction peripheral, or the like capable of executing the print process in an inkjet scheme.

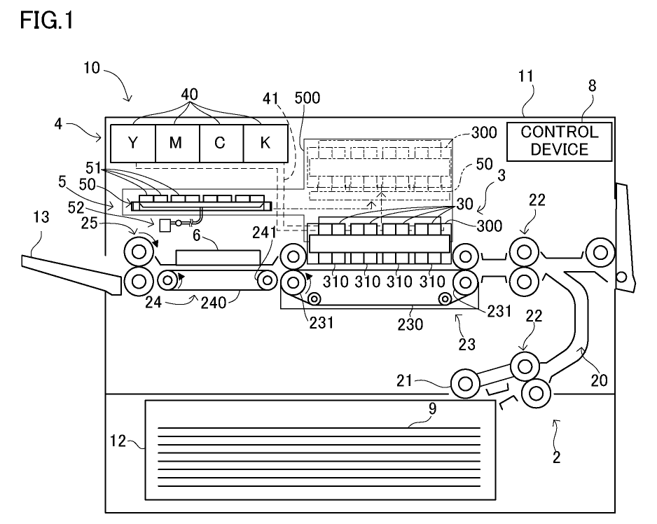

As shown in FIG. 1, the inkjet recording apparatus 10 includes a sheet storing portion 12, a sheet conveying device 2, an ink ejection device 3, a drying device 6, a control device 8, and the like. The sheet conveying device 2, the ink ejection device 3, the drying device 6, and the control device 8 are stored in a housing 11 that forms the body.

The ink ejection device 3 includes an ink supply device 4, a plurality of inkjet heads 30, and an ink discharge device 5. The ink supply device 4 supplies the plurality of inkjet heads 30 with ink.

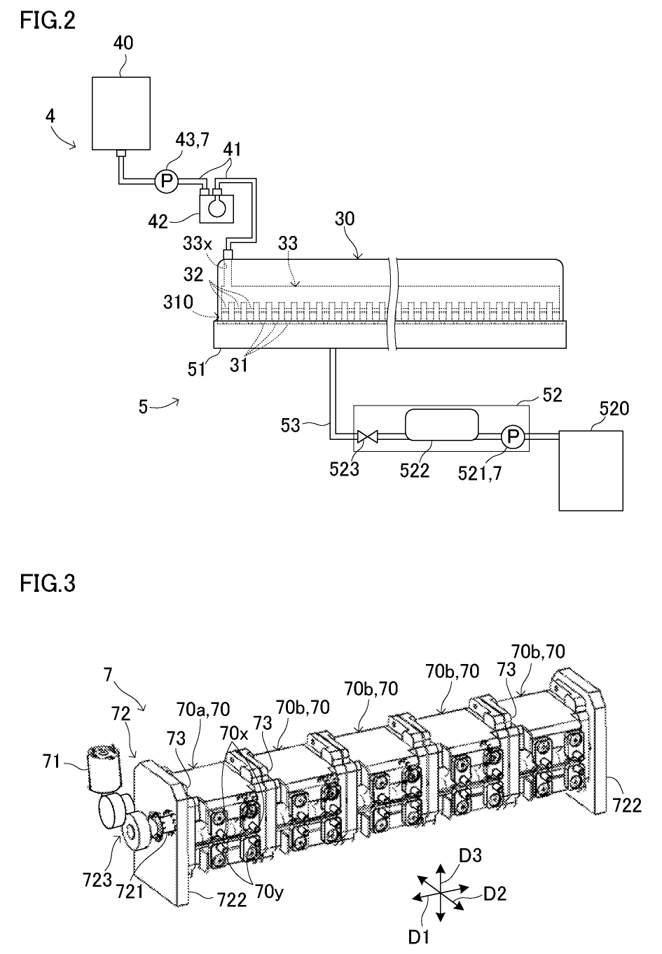

Each of the inkjet heads 30 includes a nozzle group 310 including a plurality of nozzles 31 (see FIGS. 1 and 2). Each of the plurality of nozzles 31 ejects an ink drop. The ink discharge device 5 executes an ink discharge process of discharging ink from each of the plurality of inkjet heads 30.

The sheet storing portion 12 is capable of storing the plurality of sheets 9. The sheet conveying device 2 conveys each of the sheets 9 stored in the sheet storing portion 12 along a sheet conveyance path 20 and further discharges each of the sheets 9 from the sheet conveyance path 20 to a discharge tray 13.

The sheet conveying device 2 includes a sheet feeding mechanism 21, a plurality of conveying roller pairs 22, a main conveying unit 23, a downstream conveying unit 24, a discharge roller pair 25, and the like. The sheet feeding mechanism 21 feeds each of the sheets 9 from the sheet storing portion 12 to the sheet conveyance path 20.

The plurality of conveying roller pairs 22 succeeds the sheet feeding mechanism 21 in conveying the sheets 9 and conveys the sheets 9 toward the main conveying unit 23.

The main conveying unit 23 is disposed below the plurality of inkjet heads 30. The main conveying unit 23 conveys each of the sheets 9 along the nozzle groups 310 of the plurality of inkjet heads 30.

In the main conveying unit 23, a plurality of tension rollers 231 supports and rotates an endless main conveying belt 230. The main conveying unit 23 hereby conveys each of the sheets 9 on the upper surface of the main conveying belt 230 and further feeds each of the sheets 9 to the downstream conveying unit 24. The portion between the upper surface of the main conveying belt 230 and the plurality of inkjet heads 30 forms a part of the sheet conveyance path 20.

The downstream conveying unit 24 is disposed on the downstream side of the main conveying unit 23 located at a reference position in the sheet conveying direction.

In the downstream conveying unit 24, a plurality of tension rollers 241 supports and rotates an endless downstream conveying belt 240. The downstream conveying unit 24 hereby conveys each of the sheets 9 on which an image is formed on the upper surface of the downstream conveying belt 240 and further feeds each of the sheets 9 to the discharge roller pair 25.

The drying device 6 dries ink on each of the sheets 9 conveyed by the downstream conveying unit 24 by blowing hot air to the sheet 9. The discharge roller pair 25 discharges each of the sheets 9 on which an image is formed to the discharge tray 13.

### Configuration of Inkjet Head 30

Each of the inkjet heads 30 executes an ink ejection process of ejecting an ink drop from each of the plurality of nozzles 31. The plurality of inkjet heads 30 forms an image on each of the sheets 9 conveyed by the main conveying unit 23 by ejecting an ink drop to the sheet 9.

Each of the inkjet heads 30 includes an inlet path 33 that communicates with the plurality of nozzles 31 (see FIG. 2). Ink to be supplied by the ink supply device 4 is supplied to the plurality of nozzles 31 through the inlet path 33.

Furthermore, each of the inkjet heads 30 includes a plurality of piezoelectric elements 32 corresponding to the plurality of nozzles 31 (see FIG. 2). Each of the piezoelectric elements 32 is vibrated by an ejection driving signal supplied from the control device 8. Each of the piezoelectric elements 32 pressurizes ink by being vibrated and causes the nozzle 31 to jet ink.

The ink ejection process is an example of a liquid ejection process of ejecting a liquid drop. Each of the inkjet heads 30 is an example of a liquid ejection head that executes the liquid ejection process. The ink ejection device 3 is an example of a liquid ejection device including the liquid ejection head.

### Configuration of Ink Supply Device 4

The ink supply device 4 includes a plurality of ink containers 40 and a plurality of supply paths 41 (see FIGS. 1 and 2). Each of the ink containers 40 stores ink. The supply paths 41 are connected to the respective ink containers 40 and the respective inkjet heads 30.

The plurality of ink containers 40 stores inks having colors different from each other. The plurality of inkjet heads 30 ejects inks having colors different from each other. In this embodiment, the colors of inks include the four colors of black, cyan, magenta, and yellow.

Each of the ink containers 40 is an example of a liquid storage portion that stores liquid. The ink is an example of liquid.

Each of the supply paths 41 is a channel in which the ink supplied from each of the ink containers 40 to the inkjet head 30 flows.

The ink supply device 4 supplies ink to each of the inkjet heads 30 from the ink container 40 through the supply path 41.

The ink supply device 4 further includes a pressure control valve device 42 and a pressure pump 43 each disposed in the supply path 41 (see FIG. 2).

The pressure control valve device 42 is temporarily switched from a supply path closed state to a supply path open state in response to a pressure change made in the supply path 41 by an ink drop ejected by each of the inkjet heads 30. The supply path closed state is a state in which the supply path 41 is blocked.

In contrast, the supply path open state is a state in which the supply path 41 is unblocked. The pressure control valve device 42 is switched to the supply path open state to replenish each of the inkjet heads 30 with ink in response to an ink drop ejected by the inkjet head 30.

The pressure pump 43 is disposed at the portion between the ink container 40 and the pressure control valve device 42 in the supply path 41. The pressure pump 43 pressurizes the ink in the supply path 41.

In the ink ejection device 3, the ink discharge device 5 executes the ink discharge process for discharging an air bubble or a foreign object in each of the inkjet heads 30 along with ink. The ink discharge device 5 is an example of a liquid discharge device that discharges the liquid in the liquid ejection head.

### Configuration of Ink Discharge Device 5

The ink discharge device 5 includes a cap unit 50, a unit moving device 500, a discharge path 53, and a suction device 52 (see FIG. 1). The discharge path 53 is a channel for ink flowing from the inside of a cap 51 into an ink collection container 520.

The cap unit 50 includes the cap 51 capable of covering each of the nozzle groups 310 of the plurality of inkjet heads 30 (see FIGS. 1 and 2). The discharge path 53 communicates with the inside of the cap 51 and the inside of the ink collection container 520. The suction device 52 suctions air from the inside of the cap 51 that covers the nozzle group 310 (see FIG. 2).

The ink discharge process is a process of discharging the ink in each of the plurality of inkjet heads 30 through the cap 51 and the discharge path 53 by suctioning the air in the cap 51.

The execution of the ink discharge process discharges the ink in each of the inkjet heads 30 and the ink supply device 4 supplies new ink to each of the inkjet heads 30.

The cap unit 50 is supported so as to be movable. In this embodiment, a head unit 300 including the plurality of inkjet heads 30 is also supported so as to be movable. The unit moving device 500 moves the cap unit 50 and the head unit 300.

After moving the head unit 300 from the reference position to a head retraction position, the unit moving device 500 moves the cap unit 50 from a cap retraction position to a cap position.

The reference position is a position of the head unit 300 for disposing the nozzle groups 310 along the main conveying belt 230. The head retraction position is a position farther from the main conveying belt 230 than the reference position.

The cap retraction position is a position at which the head unit 300 is not interfered with. The cap position is a position of the cap unit 50 for the caps 51 to cover the nozzle groups 310 of the plurality of inkjet heads 30.

The suction device 52 comes into operation in a situation in which the cap unit 50 is located at the cap position. This executes the ink discharge process.

The suction device 52 includes a suction pump 521, a buffer tank 522, and a control valve 523 each disposed in the discharge path 53 (see FIG. 2). The control valve 523 is a valve device switchable to a discharge path closed state and a discharge path open state in accordance with an input control signal.

The discharge path closed state is a state in which the discharge path 53 is blocked. The discharge path open state is a state in which the discharge path 53 is unblocked.

The buffer tank 522 is disposed at the portion of the discharge path 53 between the cap 51 and the suction pump 521. The buffer tank 522 temporarily stores air and the ink flowing in the discharge path 53.

The control valve 523 is disposed at the portion of the discharge path 53 between the cap 51 and the buffer tank 522.

The suction pump 521 is disposed at the portion of the discharge path 53 between the buffer tank 522 and the ink collection container 520.

The control valve 523 is switched to the discharge path closed state and the discharge path open state in accordance with an input control signal. The discharge path closed state is a state in which the discharge path 53 is blocked. The discharge path open state is a state in which the discharge path 53 is unblocked.

The ink discharge device 5 executes a preparation operation before the ink discharge process. The preparation operation is an operation of coming to a stop after the suction pump 521 comes into operation when the control valve 523 is in the discharge path closed state.

For example, in the preparation operation, the suction pump 521 remains in operation until a sense value of a pressure sensing device that senses the pressure in the buffer tank 522 decreases to a target pressure. Alternatively, in the preparation operation, the suction pump 521 remains in operation for time defined in advance.

The ink discharge device 5 executes the ink discharge process using a valve switch operation of switching the control valve 523 from the discharge path closed state to the discharge path open state after the preparation operation is executed.

The ink discharge device 5 executes the preparation operation to decrease the pressure in the buffer tank 522. The ink discharge device 5 executes the valve switch operation to cause the negative pressure in the buffer tank 522 to suction the ink in each of the inkjet heads 30.

The suction device 52 comes into operation to discharge the ink in each of the inkjet heads 30 through the cap 51 and the discharge path 53 and supply new ink from the ink supply device 4 into each of the inkjet heads 30.

Incidentally, a tube pump 7 is adopted in some cases as the pressure pump 43 or the suction pump 521 (see FIG. 2). In this embodiment, both the pressure pump 43 and the suction pump 521 are the tube pumps 7.

In a case where the tube pump 7 is adopted as the pressure pump 43 or the suction pump 521, the tube pump 7 is required to have different ejection performance depending on the model of the ink ejection device 3. In addition, the pressure pump 43 and the suction pump 521 are each required to have different ejection performance.

It is desirable in the ink ejection device 3 to allow the ejection performance of the tube pump 7 to be changed at low cost depending on the required specifications.

In this embodiment, the tube pump 7 includes a component that changes the ejection performance at low cost depending on the required specifications. Hereinafter, the configuration of the tube pump 7 will be described.

### Configuration of Tube Pump 7

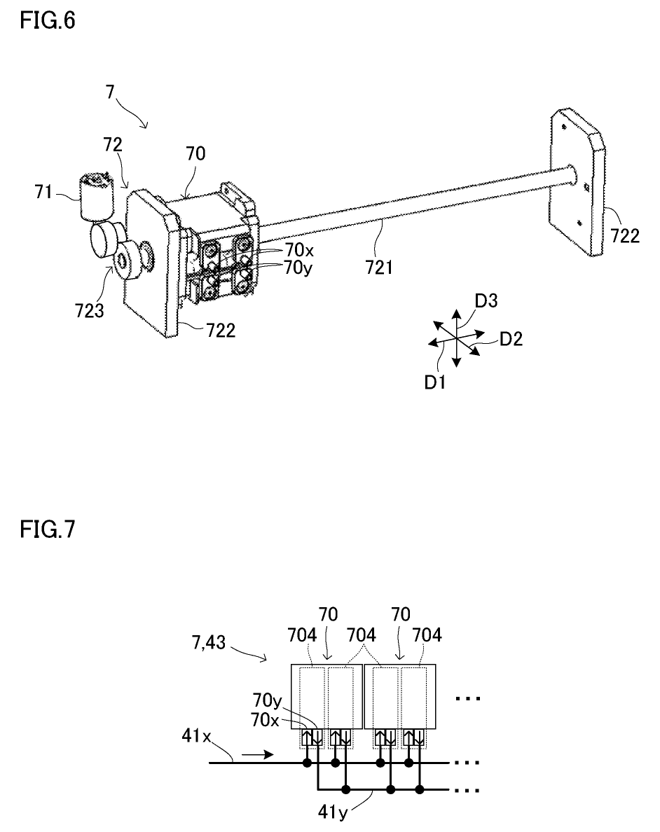

The tube pump includes one motor 71, a transmission mechanism 72, a plurality of pump units 70 (see FIGS. 3 and 6). The motor 71 is an example of a driving source that outputs rotary force.

The transmission mechanism 72 transmits the rotary force of the motor 71 to the plurality of pump units 70. Each of the plurality of pump units 70 is couplable to the transmission mechanism 72.

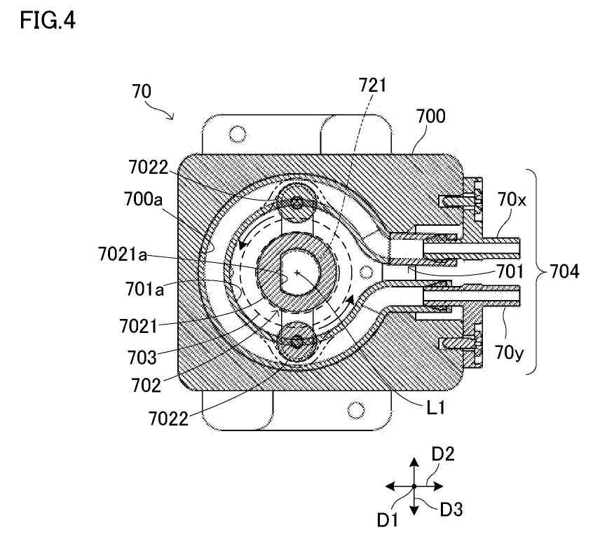

Each of the plurality of pump units 70 includes a body 700, one or more inlet ports 70x, one or more outlet ports 70y, one or more flexible tubes 701, and one or more rotors 702 (see FIG. 4).

The body 700 is a member including an arcuate inner surface 700a formed in the shape of a circular arc (see FIG. 4). For example, the body 700 is a resin member including a hollow portion.

The inlet port 70x and the outlet port 70y are supported by the body 700 and each form a channel for fluid. In this embodiment, the inlet ports 70x and the outlet ports 70y are channels each for ink and air.

The tube 701 disposed in the body 700 and includes an arcuate portion 701a disposed along the arcuate inner surface 700a (see FIG. 4). An end of the tube 701 is connected to the inlet port 70x and the other end of the tube 701 is connected to the outlet port 70y.

The rotor 702 is supported by a rotary support portion 703 of the body 700 so as to be rotatable (see FIG. 4). The rotor 702 includes a shaft engagement portion 7021 and a plurality of rollers 7022. The shaft engagement portion 7021 is a portion that receives the rotary force from the transmission mechanism 72.

Each of the plurality of rollers 7022 is supported by the rotor 702 so as to be rotatable. Each of the plurality of rollers 7022 presses a part of the arcuate portion 701a in the tube 701. Each of the rollers 7022 crushes the part of the arcuate portion 701a by sandwiching the part of the arcuate portion 701a between the roller 7022 and the arcuate inner surface 700a.

The rotor 702 rotates upon receiving the rotary force transmitted by the transmission mechanism 72. This causes each of the rollers 7022 to pivot on a center axis L1 of rotation of the rotor 702 while crushing the part of the arcuate portion 701a.

Each of the rollers 7022 pivots from a portion of the tube 701 closer to the inlet port 70x to a portion closer to the outlet port 70y. This causes ink or air to flow into the tube 701 from the inlet port 70x and further flow out of the tube 701 through the outlet port 70y.

In this embodiment, the transmission mechanism 72 includes a shaft member 721, a supporting shaft portion 722, and a shaft rotating mechanism 723. The shaft member 721 is a shaft having a non-circular cross-sectional shape.

In the example shown in FIG. 4, the shaft member 721 is a shaft subjected to so-called D-cut machining. It is noted that the shaft member 721 may have a polygonal cross-sectional shape.

The supporting shaft portion 722 supports the shaft member 721 to allow the shaft member 721 to rotate. The shaft rotating mechanism 723 transmits the rotary force of the motor 71 to the shaft member 721. In the example shown in FIG. 3, the shaft rotating mechanism 723 is a gear mechanism. It is noted that the shaft rotating mechanism 723 may be a mechanism which transmits the rotary force using an endless belt or an endless chain.

In the rotor 702 of each of the plurality of pump units 70, an engagement hole 7021a extending through the shaft engagement portion 7021 in a first direction D1 is formed in the shaft engagement portion 7021 (see FIG. 4). The engagement hole 7021a is formed to have a shape along the outer peripheral surface of the shaft member 721.

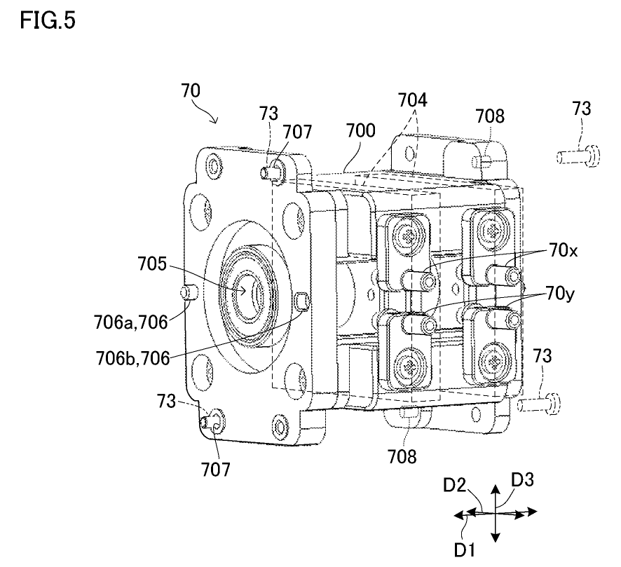

A through hole 705 that communicates with the engagement hole 7021a is formed in the body 700 of each of the plurality of pump units 70 (see FIG. 5).

The shaft member 721 is inserted to the engagement hole 7021a of the shaft engagement portion 7021 to engage the shaft engagement portion 7021 with the shaft member 721. The rotation of the shaft member 721 in a state in which the shaft engagement portion 7021 is engaged with the shaft member 721 rotates the rotor 702 along with the shaft member 721.

FIG. 6 shows a state in which the shaft member 721 is engaged with the shaft engagement portion 7021 of only one of the plurality of pump units 70.

In FIGS. 3-6, the first direction D1 is the longitudinal direction of the shaft member 721 supported by the supporting shaft portion 722. In addition, a second direction D2 is a direction orthogonal to the first direction D1 and a third direction D3 is a direction orthogonal to the first direction D1 and the second direction D2.

The shaft member 721 is inserted to the engagement holes 7021a of the shaft engagement portions 7021 in the plurality of pump units 70 to couple the plurality of pump units 70 to the transmission mechanism 72. The plurality of pump units 70 is coupled to the transmission mechanism 72 in a state in which the plurality of pump units 70 is arranged in the first direction D1 (see FIG. 3).

In addition, the rotation of the shaft member 721 rotates the rotors 702 of all the plurality of pump units 70. That is, the one motor 71 comes into operation to bring all the plurality of pump units 70 into operation.

In this embodiment, the tube pump 7 further includes a plurality of screws 73. The plurality of screw 73 couples the plurality of respective pump units 70 to a plurality of adjacent members that is disposed adjacent to the plurality of respective pump units 70 in the first direction D1.

The plurality of adjacent members is a part of the supporting shaft portion 722 and the plurality of pump units 70. The plurality of screws 73 is an example of a plurality of coupling members. It is noted that the plurality of respective pump units 70 may be coupled to the plurality of adjacent members by clamping or thermal welding.

The following description refers to one unit of the plurality of pump units 70 that is adjacent to the supporting shaft portion 722 as a first pump unit 70a and refers to the other one or more units as second pump units 70b (see FIG. 3).

The first pump unit 70a is coupled to the supporting shaft portion 722 by some of the plurality of screws 73. The one or more second pump units 70b are coupled to the adjacent first pump units 70a or the other second pump units 70b by some of the plurality of screws 73.

That is, the plurality of adjacent members includes the supporting shaft portion 722 adjacent to the first pump units 70a and the first pump units 70a adjacent to the second pump units 70b or the other second pump units 70b.

The body 700 of each of the plurality of pump units 70 has an insertion hole 707 formed on one side in the first direction D1 and a screw hole 708 formed on the other side in the first direction D1 (see FIG. 5). The insertion hole 707 is a through hole along the first direction D1. The screw hole 708 is a hole having a screw thread formed therein. Each of the screws 73 is screwed into the screw hole 708.

Although not shown, the screw hole 708 is also formed in the supporting shaft portion 722. That is, each of the plurality of adjacent members has the screw hole 708.

Each of the plurality of screws 73 is inserted to the insertion hole 707 of a target pump unit that is a target to be coupled among the plurality of pump units 70. The screw 73 is screwed into the screw hole 708 of the member adjacent to the target pump unit of the plurality of adjacent members.

Furthermore, the body 700 of each of the plurality of pump units 70 includes a rotation stopping portion 706 (see FIG. 5). The rotation stopping portions 706 prevent, by being engaged with the plurality of respective adjacent members, the plurality of respective pump units 70 from being rotating around the shaft member 721.

In this embodiment, the rotation stopping portion 706 includes a protruding portion 706a and a recessed portion 706b formed on an end face of the body 700 in the first direction D1 (see FIG. 5). Although not shown, the protruding portion 706a and the recessed portion 706b are also formed in the supporting shaft portion 722.

The protruding portions 706a and the recessed portions 706b of the plurality of respective pump units 70 are engaged with the recessed portions 706b and the protruding portions 706a of the plurality of respective adjacent members.

The plurality of pump units 70 is coupled by the plurality of screws 73 in a state in which the rotation stopping portions 706 of the plurality of respective pump units 70 are engaged with the plurality of respective adjacent members.

For example, each of the pump units 70 includes a plurality of pump element sets 704 each including the inlet port 70x, the outlet port 70y, the tube 701, and the rotor 702 (see FIGS. 4 and 5). In this embodiment, each of the pump units 70 includes the two pump element sets 704.

FIG. 7 shows an example of a connection mode between the plurality of pump units 70 and the supply path 41 in a case where the tube pump 7 is disposed in the supply path 41 as the pressure pump 43. The following description refers to the portion of the supply path 41 on the upstream side of the tube pump 7 as a primary supply path 41x and refers to the portion of the supply path 41 on the downstream side of the tube pump 7 as a secondary supply path 41y (see FIG. 7).

For example, the inlet ports 70x of the plurality of pump units 70 are connected to the primary supply path 41x in parallel. Similarly, the outlet ports 70y of the plurality of pump units 70 are connected to the secondary supply path 41y in parallel.

Additionally, in a case where the tube pump 7 is disposed in the discharge path 53 as the suction pump 521, the plurality of pump units 70 and the discharge path 53 are also connected as in the example shown in FIG. 7.

It is possible to easily change the ejection performance of the tube pump 7 at low cost by changing the number of pump units 70 depending on the required specifications.

### Modification

The tube pump 7 described above may be applied to another liquid ejection device that ejects liquid other than ink.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

A tube pump including:
one driving source configured to output rotary force;
a transmission mechanism configured to transmit the rotary force of the driving source; and
a plurality of pump units each couplable to the transmission mechanism, in which
each of the plurality of pump units includes
a body having an arcuate inner surface formed in a shape of a circular arc,
an inlet port and an outlet port that are supported by the body, the inlet port and the outlet port each forming a channel for fluid,
a flexible tube disposed in the body and connected to the inlet port and the outlet port, the flexible tube including an arcuate portion disposed along the arcuate inner surface, and
a rotor including a plurality of rollers each configured to press a part of the arcuate portion in the tube, the rotor being configured to rotate upon receiving the rotary force transmitted by the transmission mechanism.

### Supplementary Note 2

The tube pump according to Supplementary Note 1, in which
the transmission mechanism includes
a shaft member having a non-circular cross-sectional shape,
a supporting shaft portion configured to support the shaft member to allow the shaft member to rotate, and
a shaft rotating mechanism configured to transmit the rotary force of the driving source to the shaft member, and
the rotor of each of the plurality of pump units includes a shaft engagement portion configured to be engaged with the shaft member by insertion of the shaft member.

### Supplementary Note 3

The tube pump according to Supplementary Note 2, including a plurality of coupling members configured to couple the plurality of respective pump units to a plurality of adjacent members disposed adjacent to the plurality of respective pump units in a longitudinal direction of the shaft member, in which
the plurality of respective pump units includes rotation stopping portions configured to prevent, by being engaged with the plurality of respective adjacent members, the plurality of respective pump units from being rotating around the shaft member, and
plurality of adjacent members is a part of the supporting shaft portion and the plurality of pump units.

### Supplementary Note 4

A liquid ejection device including:
a liquid ejection head including a plurality of nozzles, the liquid ejection head being configured to eject a liquid drop from each of the plurality of nozzles;
a supply path in which liquid to be supplied to the liquid ejection head flows; and
the tube pump according to any one of Supplementary Notes 1 to 3, the tube pump being disposed in the supply path.

### Supplementary Note 5

A liquid ejection device including:
a liquid ejection head including a plurality of nozzles, the liquid ejection head being configured to eject a liquid drop from each of the plurality of nozzles; and
a liquid discharge device configured to discharge liquid in the liquid ejection head, in which
the liquid discharge device includes
a cap configured to cover the plurality of nozzles,
a discharge path that communicates with inside of the cap, and
the tube pump according to any one of Supplementary Notes 1 to 3, the tube pump being disposed in the discharge path.

### Supplementary Note 6

An inkjet recording apparatus including:
a sheet conveying device configured to convey a sheet; and
the liquid ejection device according to Supplementary Note 5, the liquid ejection device being configured to form an image on the conveyed sheet by ejecting an ink drop to the sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A tube pump comprising:
one driving source configured to output rotary force;
a transmission mechanism configured to transmit the rotary force of the driving source; and
a plurality of pump units each couplable to the transmission mechanism, wherein
each of the plurality of pump units includes
a body having an arcuate inner surface formed in a shape of a circular arc,
an inlet port and an outlet port that are supported by the body, the inlet port and the outlet port each forming a channel for fluid,
a flexible tube disposed in the body and connected to the inlet port and the outlet port, the flexible tube including an arcuate portion disposed along the arcuate inner surface, and
a rotor including a plurality of rollers each configured to press a part of the arcuate portion in the tube, the rotor being configured to rotate upon receiving the rotary force transmitted by the transmission mechanism.

2. The tube pump according to claim 1, wherein
the transmission mechanism includes
a shaft member having a non-circular cross-sectional shape,
a supporting shaft portion configured to support the shaft member to allow the shaft member to rotate, and
a shaft rotating mechanism configured to transmit the rotary force of the driving source to the shaft member, and
the rotor of each of the plurality of pump units includes a shaft engagement portion configured to be engaged with the shaft member by insertion of the shaft member.

3. The tube pump according to claim 2, comprising a plurality of coupling members configured to couple the plurality of respective pump units to a plurality of adjacent members disposed adjacent to the plurality of respective pump units in a longitudinal direction of the shaft member, wherein
the plurality of respective pump units includes rotation stopping portions configured to prevent, by being engaged with the plurality of respective adjacent members, the plurality of respective pump units from being rotating around the shaft member, and
the plurality of adjacent members is a part of the supporting shaft portion and the plurality of pump units.

4. A liquid ejection device comprising:
a liquid ejection head including a plurality of nozzles, the liquid ejection head being configured to eject a liquid drop from each of the plurality of nozzles;
a supply path in which liquid to be supplied to the liquid ejection head flows; and
the tube pump according to claim 1, the tube pump being disposed in the supply path.

5. A liquid ejection device comprising:
a liquid ejection head including a plurality of nozzles, the liquid ejection head being configured to eject a liquid drop from each of the plurality of nozzles; and
a liquid discharge device configured to discharge liquid in the liquid ejection head, wherein
the liquid discharge device includes
a cap configured to cover the plurality of nozzles,
a discharge path that communicates with inside of the cap, and
the tube pump according to claim 1, the tube pump being disposed in the discharge path.

6. An inkjet recording apparatus comprising:
a sheet conveying device configured to convey a sheet; and
the liquid ejection device according to claim 5, the liquid ejection device being configured to form an image on the conveyed sheet by ejecting an ink drop to the sheet.
